(19) United States
(12) Patent Application Publication
(10) Pub. No.: US 2023/0376851 A1
(43) Pub. Date: Nov. 23, 2023

(54) EFFICIENT TRANSFORMER WITH SERIAL COMPOSITION OF MULTI-SCALE MULTI-RANGE ATTENTIONS

(71) Applicant: QUALCOMM Incorporated, San Diego, CA (US)

(72) Inventors: Mingu LEE, San Diego, CA (US); Saurabh Kedar PITRE, San Diego, CA (US); Tianyu JIANG, San Diego, CA (US); Christopher LOTT, San Diego, CA (US)

(21) Appl. No.: 18/319,259

(22) Filed: May 17, 2023

Related U.S. Application Data
(60) Provisional application No. 63/364,947, filed on May 18, 2022.

(51) Int. Cl. G06N 20/00

(52) U.S. Cl. CPC G06N 20/00

(57) ABSTRACT

Certain aspects of the present disclosure provide techniques and apparatus for performing machine learning. In one example, an input data sequence is accessed, and the input data sequence is sliced based on a slice length hyperparameter to generate a stacked slice input data representation. The stacked slice input data representation is processed with a slice attention layer to generate a stacked slice output data representation. The stacked slice output data representation is de-sliced to generate an output data sequence.

### CROSS-REFERENCE TO RELATED APPLICATIONS

This application claims priority to U.S. Provisional Patent Application No. 63/364,947, filed May 18, 2022, the entire contents of which are incorporated herein by reference in their entirety.

### INTRODUCTION

Aspects of the present disclosure relate to efficient transformer-based machine learning model architectures.

Transformer network architectures provide state-of-the-art performance and versatility in many domains, and have recently been regarded as one of the most important recent advancements in artificial intelligence. However, transformer-based model architectures are notoriously expensive in terms of computation and memory requirements owing to their O(N²) complexity, which increases quadratically with respect to input length N. This complexity problem often prohibits using transformer-based model architectures for tasks with long sequence data, and additionally limits the range of devices upon which such model architectures can be deployed.

Conventional attempts to reduce the complexity of transformer-based model architectures often do so with a significant trade-off in accuracy. Accordingly, improved transformer-based machine learning model architectures are needed.

### BRIEF SUMMARY

Certain aspects provide a computer-implemented method, comprising: accessing an input data sequence; slicing the input data sequence based on a slice length hyperparameter to generate a stacked slice input data representation; processing the stacked slice input data representation with a slice attention layer to generate a stacked slice output data representation; and de-slicing the stacked slice output data representation to generate an output data sequence.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of the one or more aspects and are therefore not to be considered limiting of the scope of this disclosure.

FIG. 1 depicts an example of an attention function.

FIG. 2 depicts an example of an efficient transformer-based model.

FIG. 3 depicts an example slice attention layer architecture.

FIG. 4 depicts an example data flow for slice attention.

FIG. 5 depicts an example data flow for slice attention with slice overlap.

FIG. 6 depicts an example data flow for slice attention with focal overlap.

FIG. 7 depicts an example workflow for focal local attention.

FIG. 8 depicts an example method for performing machine learning with slice attention.

FIG. 9 depicts an example processing system.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for efficient transformer-based machine learning model architectures.

With state-of-the-art performance and versatility in many domains, transformer-based neural network architectures represent a core technology for modern machine learning and artificial intelligence applications. Transformers are one of the most popular contemporary neural network architectures because they have achieved exceptional results on various types of challenging language tasks, and are more recently being applied to vision tasks as well.

However, conventional transformer-based models are notoriously expensive due to inherently high complexity. Conventional transformers suffer due to a variety of problems, including quadratic computational and memory complexity with respect to input data sequence length (e.g., O(N²) based on an input data sequence length N), as well as reduced task performance (e.g., reduced accuracy) when modeling longer sequences.

Previous attempts to solve the technical complexity problem with transformer-based models have come at the cost of significant performance tradeoffs. That is, conventional transformer-based models that have been made more efficient in terms of complexity, have also been made less performant (e.g., with reduced accuracy). For example, some transformer designs that specialize in optimizing for longer sequence modeling (but add additional overhead for shorter sequence modeling) are generally not universally applicable to different tasks.

To overcome these and other technical problems with conventional transformer-based model architectures, some aspects described herein relate to efficient transformer-based neural network architectures. In some aspects, the transformer-based neural network architectures use a serial composition of attentions at different scales applied to a stacked slice representation of an input sequence, and/or multi-scale positional embeddings that are instantly applied at attention time. In some aspects, the model architectures described herein may be referred to as “composite slice transformers.” Notably, with a fixed slice length L as a hyperparameter, the efficient transformer-based neural network architectures described herein have complexity of O(NL+N²/L²), which is comparable to or even more efficient than linear complexity in practical settings, and which in any event is significantly more efficient than the complexity of conventional transformer-based models, O(N²).

As the efficient transformer-based neural network architectures described herein involve or use slicing of an input sequence, some aspects described herein relate to overlapped or focal attention techniques that capture token interaction (where a “token” is an element or value in the input sequence) across slice boundaries seamlessly, preventing context fragmentation. The efficient transformer-based neural network architectures described herein can therefore achieve competitive performances (e.g., high accuracy) in many different tasks while achieving state-of-the-art performance on the Long Range Arena benchmark, which consists of 5 long sequence classification tasks that evaluate the model performance on long sequences. This metric measures both efficiency and performance as the model has to deal with the N² complexity caused by the long sequences.

### Brief Introduction to Self-Attention

In aspects of the present disclosure, transformer-based architectures, which utilize (self-)attention functions to draw global dependencies between inputs and outputs, are described. An attention function can generally be described as a function configured to map a query and a set of key-value pairs to an output, where the query, keys, values, and output are all vectors. In some aspects, the output is computed as a weighted sum of the values, where the weight assigned to each value is computed by a compatibility function of the query with the corresponding key.

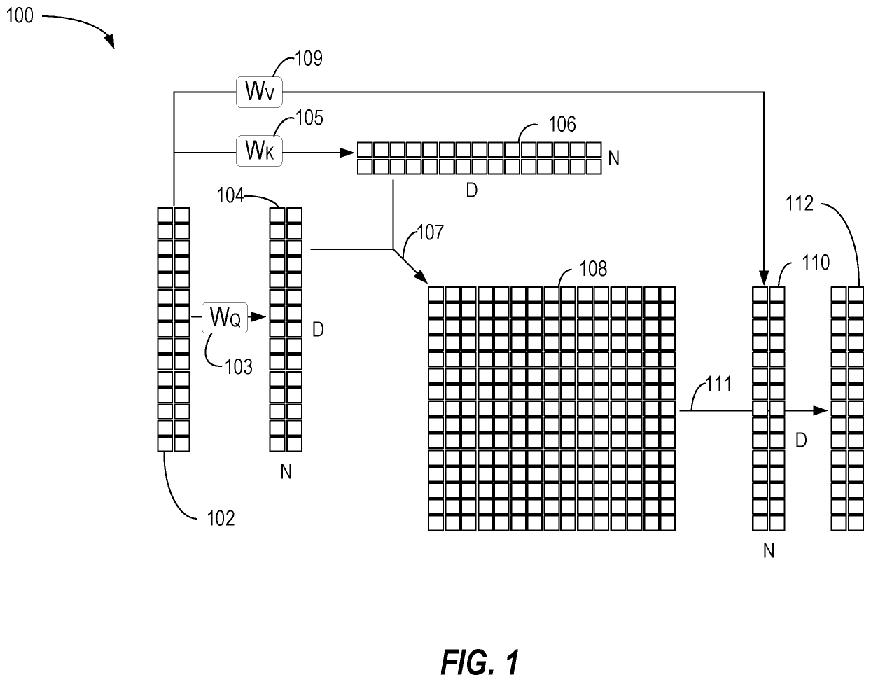

FIG. 1 depicts an example attention mechanism 100 in which an input matrix 102 is weighted by trainable parameters including a query weight 103, key weight 105, and value weight 109 to generate query matrix 104, key matrix 106, and value matrix 110, respectively. That is, the input matrix 102 is weighted (e.g., multiplied) with a set of one or more learned query weights 103 (denoted W_{Q} in the illustrated example) in order to generate a query matrix 104 (also referred to in some aspects as “queries”). Sequentially or in parallel, the input matrix 102 is weighted (e.g., multiplied) with a set of one or more learned key weights 105 (denoted W_{K} in the illustrated example) in order to generate a key matrix 106 (also referred to in some aspects as “keys”), and input matrix 102 is weighted (e.g., multiplied) with a set of one or more learned value weights 109 (denoted W_{V} in the illustrated example) in order to generate a value matrix 110 (also referred to in some aspects as “values”). In some aspects, these multiplications (to create query matrix 104, key matrix 106, and/or value matrix 110) may be referred to as element-wise or Hadamard multiplications or products.

In the illustrated example, the query matrix 104 and key matrix 106 are then aggregated or combined (e.g., using matrix multiplication of the two matrices 104 and 106), as depicted by arrow 107, to generate an intermediate matrix 108. Notably, in the illustrated example, the input matrix can have dimensionality N×D (e.g., size N*D). After applying the learned weights 103, 105, and 109, the resulting matrices may have equal size N*D. That is, as illustrated, the query matrix 104 and value matrix 110 each have dimensionality N×D (e.g., size N*D), while the key matrix 106 has dimensionality D×N (e.g., size D*N).

However, as the intermediate matrix 108 is generated using matrix multiplication (e.g., via arrow 107) of the query matrix 104 and key matrix 106, the intermediate matrix 108 generally has dimensionality N×N (e.g., size N²). As discussed above, this results in the O(N²) complexity in conventional architectures.

In the illustrated example, the intermediate matrix 108 is then weighted (e.g., multiplied) with the value matrix 110 (using operation 111, which may correspond to a matrix multiplication operation) to generate the output matrix 112, which serves as output from the attention mechanism 100. In the illustrated example, the output matrix 112 is of the same dimensionality and size as the input matrix 102 (e.g., dimensionality N×D with size N*D).

### Transformers and Multi-Head Self-Attention

In some aspects, transformer layers in a neural network model cam include a multi-head self-attention sublayer followed by a feed-forward network with an optional cross-attention sublayer (e.g., in the case of a decoder). The multi-head self-attention (e.g., the output matrix 112), which may serve as the main source of the sequence modeling capability of the transformers, is defined as the concatenation of self-attention outputs in all attention heads:

Y=concat[Y₀,Y₂, . . . ,Y_{H-1}] (1)

where each of the outputs Yₕ∈ [symbol] ^{N×D} is a scaled dot-product attention computed from the input X∈ [symbol] ^{N×D} (e.g., input matrix 102) as:

$${Y}_{h} = softmax ( \frac{{Q}_{h} {K}_{h}^{⊤}}{\sqrt{d}} ) {V}_{h} = A {V}_{h} . \qquad ( 2 )$$

with queries Qₕ=XW_{q,h} (e.g., a query matrix 104 generated by multiplying the input matrix 102 and a query weight 103 for the specific head h), keys Kₕ=XW_{k,h} (e.g., a key matrix 106 generated by multiplying the input matrix 102 and a key weight 105 for the specific head h), and values Vₕ=XW_{v,h} (e.g., a value matrix 110 generated by multiplying the input matrix 102 and a value weight 109 for the specific head h) as linear transformations of the input X. In some aspects, the weights (e.g., the query weight 103, key weight 105, and/or value weight 109) may be implemented as scalar values and/or as matrices (e.g., where the query weight 103, key weight 105, and value weight 109 may each comprise a matrix of weights). Here, it is assumed that the queries, keys, and values have the same hidden dimension dₕ=D/H. Thus, hereinafter, the head index h and scaling factor 1/\sqrt{d} are omitted for simplicity. Denoting the query as qᵢ∈ [symbol] ^{1×d} at query position index i, and similarly to keys and values as kⱼ and vⱼ, respectively, the attention output at ith token position yᵢ∈ [symbol] ^{1×d}^{ₕ} corresponds to:

yᵢ=softmax(qᵢK^{T})V. (3)

Due to the nonlinearity and normalization property of the softmax function, the computation of QK^{T} is performed to get the attention weight followed by aggregating the values. Thus, the computational complexities of the dot-product, QK^{T}, and the value aggregation by the attention weights, AV, are both O(N²) (and the memory complexity is also O(N²)) for A. Consequently, the self-attention is said to have quadratic complexity with respect to the sequence length N.

### Abstractive Attentions

With the assumption that softmax dot-product attention plays an important role in the sequence modeling capability of transformer models, abstractive attention retains the form of basic attention computation per Equation 3.

In aspects of the present disclosure, abstractive attentions may be defined as a family of efficient attention approaches in which the lengths of the attention operands are reduced to M(<N) by applying an abstraction function, such that the complexity of the attention is reduced accordingly. Abstractive attentions can be further be categorized to either resolution preserving or non-preserving attentions, according to which operands are chosen to be abstracted, where the preservation of resolution is between input and output sequences. That is, resolution preserving attentions preserve the resolution of the input sequence, while non-preserving attentions do not. In some aspects, when the queries (e.g., query matrix 104) are abstracted, the attention is called resolution non-preserving attention, and the abstracted attention also produces abstracted output. In some aspects, this categorization as preserving or non-preserving attentions is determined according to the given task. For instance, tasks such as language modeling and machine translation generally rely on high (or full) resolution at the output to be retained. In those cases, in some aspects, only the keys (e.g., key matrix 106) and values (e.g., value matrix 110) are abstracted while the query resolution is retained. The abstractive resolution preserving attention of this case can be expressed as below:

yᵢ=softmax(qᵢK′^{T})V′ (4)

K′=[K′₀^{T}, . . . ,k′_{j′}^{T}, . . . ,k′_{M}_{ₖ}^{T}]^{T} (5)

k′_{j′}=ϕₖ({k_{j∈Ω}_{_{j′}}}) (6)

where Ω_{j′} denotes the abstraction range with the cardinality |Ω_{j′}|=Mₖ for the j′th key abstraction k′_{j′} and ϕₖ(⋅):K_{Ω}_{_{j′}}∈ [symbol] ^{|Ω}^{_{j′}}^{|×d}^{ₕ}→K′_{j′}∈ [symbol] ^{1×d}^{ₕ} is a many-to-one abstraction function. The abstracted value V_{j′} can be expressed similarly to Equation 6.

Resolution non-preserving abstraction may be used for tasks where the output resolution is not necessary or is less important, such as sequence-level classification problems. However, with additional processing leveraging representations at a lower layer (e.g., using cross-attention with input tokens) it is possible to restore the resolution in some aspects. Along with the keys and values abstractions (discussed above with reference to Equations 5 and 6), in some aspects the queries can be abstracted as:

q_{i′}=ϕ_{q}({q_{i∈Ω}_{_{i′}}}), (7)

and the attention for resolution non-preserving attention can be defined as:

y_{i′}=softmax(q_{i′}K′^{T})V′ (8)

where an attention output vector y_{i′} is obtained at each abstract position i′. In some aspects, in order to restore the resolution of the output, a one-to-many mapping function ψ_{y} may be defined as:

{y_{i∈Ω}_{_{i′}}}=ψ_{y}(y_{i′}) (9)

In some aspects of the transformer-based architectures describe herein, as the output of the local attention maintains high (or full) resolution (e.g., because the queries are not abstracted), a simple broadcasting function may be used to restore the sequence length, i.e., yᵢ=y_{i′} for i∈Ω_{i′}, instead of restoring the resolution. Note that the term broadcasting, as used herein, describes how to treat arrays with different shapes during arithmetic operations. Subject to certain constraints, the smaller array may be “broadcast” across the larger array so that they have compatible shapes (e.g., by copying or duplicating elements of the array to create an array of the desired size)). Broadcasting provides a means of vectorizing array operations.

### Multi-Scale Multi-Range Attention

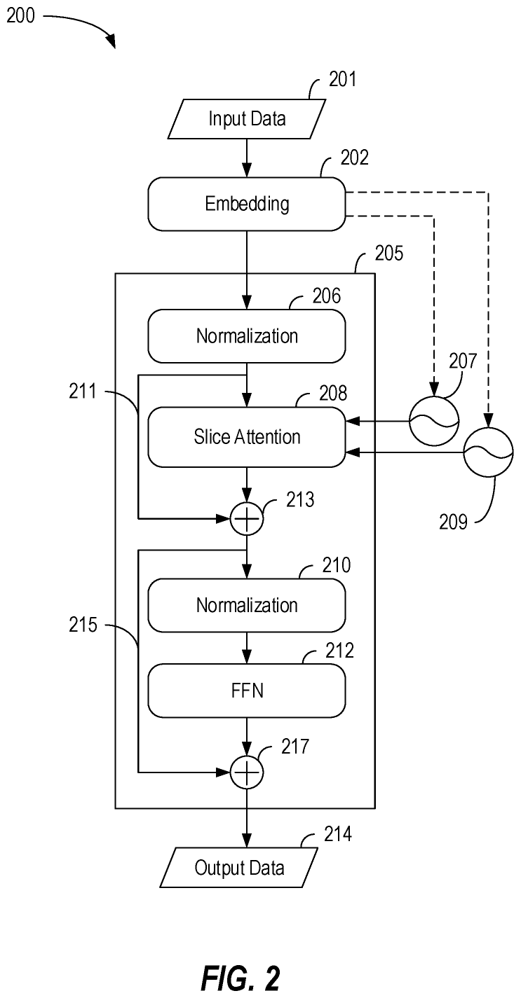

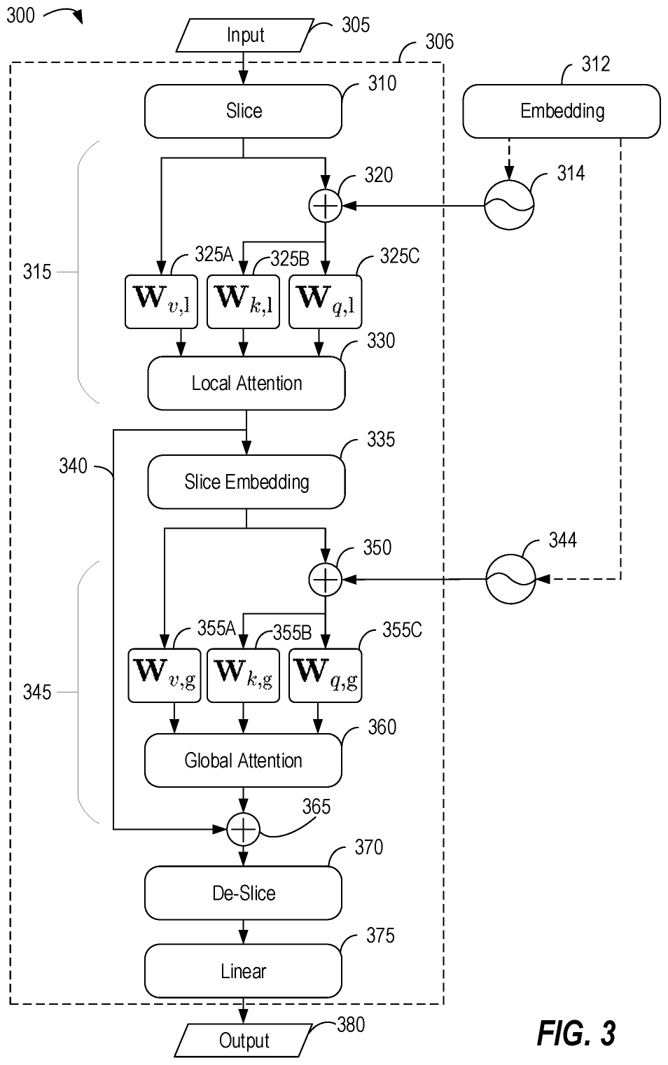

Although some previous abstractive attention and non-attention approaches have achieved sub-quadratic complexity (and even linear complexities for some methods), these prior approaches generally come at the cost of degraded performance (e.g., reduced accuracy) on benchmarks. However, the efficient transformer-based model architectures described herein leverage multi-scale attention by combining local attention and global attention and provide significant accuracy improvements (often outperforming conventional architectures) while still maintaining the efficiency benefits. An example efficient transformer-based model is described in more detail below with reference to FIG. 2, and an example slice attention architecture is discussed in more detail below with reference to FIG. 3.

In some aspects, local attention (also referred to as sliding window attention) limits the attention range to the vicinity of query locations. That is, key abstraction may be performed with the whole abstraction range, and the query abstraction may be performed using a location-dependent abstraction function:

K′ₗ=ϕ_{k,i}^{sliding}(K)=K⊙(H(i−j−w/2)−H(i−j+w/2))

where H is Heaviside step function, w is the window length, and ⊙ is an element-wise product. In some aspects, therefore, the local attention may be defined using Equation 10 below:

y_{l,i}=softmax(qᵢK′_{l,i}^{T})V′_{l,i} (10)

In some aspects, for better computational efficiency, block-wise key abstraction can be defined as K′ₗ=ϕ_{k,i}^{block}(K)=K⊙(H(tᵢ−j−w/2)−H(tᵢ−j+w/2)) for a block-wise attention where tᵢ=(b−½)w for the block index b such that (b−1)w·i<bw.

In some aspects, for the global attention, abstractive attention can be used with either positional abstractions (which may be loosely seen as having patch embeddings in vision transformers (ViTs)) and/or contextual abstractions.

In some aspects, the composite attention (with multi-scale and multi-range components) may be categorized according to how the two attentions are combined. For example one combination approach is to concatenate the abstractions of multi-scale keys and values for a single attention, such as using Equation 11 below.

y_{g,i}=softmax(qᵢ[K′_{l,i},K′_{g}]^{T})[V′ₗ^{T},V′_{g}^{T}]^{T} (11)

In some aspects, the multi-scale attention composition can be defined using separate attentions at different scales, where the outputs of each are combined or summed (possibly with some weighting coefficients), such as defined using Equation 12 below.

yᵢ=Y_{l,i}+ψ_{y}(y_{g,i}) (12)

In this latter case (where the outputs are summed or otherwise combined), other non-attentive methods, such as kernel methods, may additionally or alternatively be used for the global attention.

In some aspects, the efficient transformer-based model architectures described herein may correspond to this latter case, where the local and global attentions are performed separately and their outputs are combined (e.g., summed) together. However, unlike other architectures, such as Transformer-In-Transformer (TNT), that have independent (parallel) paths for the local attention and the global attention and therefore prevent information exchange between patches, the efficient transformer-based model architectures descripted herein use a serial connection between multi-granular attentions to enable two-way information routing. Therefore, aspects of the present disclosure may be more suitable for modeling highly non-stationary data, such as natural language text data for which a locality assumption does not hold.

### Attention with Input Slice Representations

Aspects described herein implement so-called “slice attention” in transformer-based models (thus, the term composite slice transformer), which replaces the full softmax dot-product attention of conventional transformer models. Beneficially, slice attention leverages both high-resolution attention in a limited range and abstracted attention to capture full-range interactions. Unlike previous approaches, in some aspects, the multi-scale multi-range attentions are configured using a serial connection that allows two-way information routing between the two attention mechanisms.

In a high-level description, the multi-scale multi-range attention of a composite slice transformer model corresponds to the combination of block-wise local window attention with patch-based attention. In some aspects, at the embedding layer, the composite slice transformer model converts the input sequence X∈ [symbol] ^{N×D} into a stack of slices S∈ [symbol] ^{N/L×L×D} by slicing the input sequence X based on a fixed length L (e.g., delineating the input sequence of tokens into a set of slices, each with a length of L tokens). In some aspects, the slice length hyperparameter (e.g., a hyperparameter used to define the slice length) L may be selected or defined using a variety of criteria or techniques, and can generally include any value. For example, the slice length may be selected (e.g., by a data scientist) to balance complexity and/or to improve model accuracy (e.g., using trial and error to test multiple slice lengths). In some aspects, two attentions with different granularities can then be performed sequentially in each direction, as discussed in more detail below with reference to FIG. 3.

In some aspects, the local attention is first performed across the tokens within each slice (e.g., described in more detail below with reference to section 315 in FIG. 3) while considering the number of slices as a batch. In some aspects, the slice dimension N/L can be combined with the batch dimension and parallelized together so that

Yₗ=softmax(QₗKₗ^{T})Vₗ (13)

where Qₗ, Kₗ, and Vₗ are the queries, keys, and values (respectively) for the local attention obtained by applying learnable weights W_{q,l}, W_{k,l}, and W_{v,l} to stack or slice S. Next, in some aspects, the dimension of length L in the local attention output can be collapsed using an abstraction function ϕ_{y} to get the slice embedding S′∈ [symbol] ^{N/L×D}. In some examples, a simple mean pooling ϕ_{y}(Yₛ)=Σₗ₌₀^{L-1}mₗY_{s,l}/Σₗ₌₀^{L-1} may be used where l is the token index along the length dimension and mₗ is the attention mask value. In some aspects, normalization with the sum of a mask, instead of the slice length, in each slice helps avoid biases in the mean computation induced by masked tokens.

In some aspects, the second attention across the slice dimension (e.g., global attention) is then performed (e.g., described in more detail below with reference to section 345 in FIG. 3) to model full-range information routing in a reduced resolution according to:

Y_{g}=softmax(Q_{g}K_{g}^{T})V_{g} (14)

where Q_{g}, K_{g}, and V_{g} are the queries, keys, and values (respectively) for the global attention obtained by applying W_{q,g}, W_{k,g}, and W_{v,g} to stack or slice S.

### Volatile Instant Multi-Scale Positional Embeddings

Because transformer-based models generally contain no recurrence and no convolution, in some aspects, some information about the relative or absolute position of the tokens in the sequence is injected in order for the model to make use of the order of the sequence. This may be referred to in some aspects as positional embedding (e.g., referred to in some aspects as Pₗ for local positional embeddings and P_{g} for global positional embeddings, and indicated by embedding functions 207 and 209, respectively, in FIG. 2 and embedding functions 314 and 344, respectively, in FIG. 3). In some aspects, the positional encodings generally have the same dimensionality as the token embeddings (e.g., generated at embedding layer 202 in FIG. 2 and/or embedding layer 312 in FIG. 3), so that the two can be directly summed.

In some aspects, because the lengths of both the global and local attentions are reduced (and may have different granularity) in the composite slice transformer model described herein, the full positional embeddings of the maximum input sequence length is no longer necessary (as compared to conventional architectures). In some aspects, therefore, for the local attention, the positional embedding length may be limited to the attention range (e.g., to the slice length L). In addition, because the tokens from each slice are aggregated for the global attention, it may be more natural to have separate positional embeddings of length N/L at the scale of slice embeddings, rather than aggregating the full-resolution full-length positional embeddings.

In some aspects of the composite slice transformer models described herein, therefore, multi-scale positional embeddings Pₗ∈ [symbol] ^{L×d} and P_{g}∈ [symbol] ^{N/L×d} may be used (as depicted and described in more detail below with reference to embedding functions 314 and 344 of FIG. 3). As discussed in more detail below, these multi-scale positional embeddings may be used in a different manner than in conventional transformer models in multiple ways. First, rather than adding the positional embeddings to the stacked slices of token embeddings at the embedding layer, the positional embeddings may be applied at the corresponding attentions in each layer before the linear transformations. Second, the positional embeddings in the disclosed composite slice transformer models may be added only to the queries and keys (and not to the values). This can prevent the issue of the positional embeddings accumulating over all of the layers (and therefore undesirably dominating the contextual information at top layers), which potentially leads to performance degradation. Accordingly, in some aspects, for a composite slice transformer model, Equations 13 and 14 can be rewritten as:

Yₗ=softmax((Qₗ+Pₗ)(Kₗ+Pₗ)^{T})Vₗ (15)

Y_{g}=softmax((Q_{g}+P_{g})(K_{g}+P_{g})^{T})V_{g} (16)

where Yₗ is the output from the local attention and Y_{g} is the output from the global attention.

### Complexity and Storage Improvements

In some aspects, as compared to the quadratic complexity O(N²) of conventional transformer models, the composite slice transformer models described herein have linear plus decimated quadratic complexity of O(NL)+O(N²/L²). However, because the slice length L is typically less than the abstraction length M in other models with linear complexity, composite slice transformer models have comparable efficiency to other efficient transformer models for practical lengths of input sequences.

Another benefit of using the stacked slice representation in aspects described herein is the reduction in storage for the positional embeddings. As the lengths for attentions are L and N/L for local and global attentions, respectively, composite slice transformer models have fewer parameters

$$( e . g . , ( L + \frac{N}{L} ) * D parameters )$$

than that of the conventional positional embeddings (e.g., N *D parameters in conventional transformer models).

### Example Composite Slice Transformer Model Architecture

FIG. 2 depicts an example of an efficient transformer-based model architecture 200, which has been referred to herein as a composite slice transformer model.

As illustrated, input data 201 (e.g., a sequence of tokens or elements) is provided to an embedding layer 202, which transforms the input data 201 of size [symbol] ^{N×1} to a numerical representation, such as a multi-dimensional vector of the size [symbol] ^{N×D}, where the sequence length is N and the dimensionality of each element in the sequence is D.

In the illustrated example, the numerical representation (output from the embedding layer 202) is then provided as an input to a slice attention module 205.

In this example, slice attention module 205 (also referred to as an attention head in some aspects) begins with a normalization layer 206, which normalizes the input data representation (e.g., using layer normalization) and then provides the normalized input data representation to the slice attention layer 208 (e.g., a layer of a neural network that implements or performs slice attention). An example of a slice attention layer architecture is described in further detail below with reference to FIG. 3. That is, the slice attention layer architecture of block 306 of FIG. 3 may provide additional detail for the components and/or operations of the slice attention layer 208. In addition to the normalized input data representation, as illustrated, the slice attention layer 208 also receives as inputs the local positional embedding Pₗ and the global positional embedding P_{g}, which are generated by embedding functions 207 and 209, respectively, based on the output data representation from the embedding layer 202. The output of slice attention layer 208 is generally an output data representation, in which local and global attention have been applied (as described in further detail below with reference to FIG. 3).

As illustrated, the input to the slice attention layer 208 (by way of skip connection 211) and the output of slice attention layer 208 are then summed at adder 213 to generate input for another normalization layer 210. In some aspects, the skip connection 211 is useful for stabilizing gradients and helping training convergence.

The output from normalization layer 210, a normalized output data representation, is then provided to a feed-forward network (FFN) 212, which may be configured as a pointwise fully-connected feed-forward network to have the attention output transformed nonlinearly as a new representation for the next layer. Here again, a skip connection 215 can be used to add the input to the normalization layer 210 with the output of the feed-forward network 212 by way of adder 217 in order to generate the final output data 214 from the transformer-based model architecture 200.

Although the illustrated example depicts a single slice attention module 205 (or attention head) for simplicity and conceptual clarity, in aspects, there could be a plurality of slice attention modules 205 implemented in the architecture 200 (e.g., the architecture 200 may use a multi-head slice attention mechanism).

Further, FIG. 2 depicts just one example of a composite slice transformer model architecture, and variations may be made while retaining the underlying slice attention functionality. For example, the ordering of the normalization layers may be changed from a “pre-norm” configuration, as depicted in the architecture 200 (e.g., where the normalization layers 206 and 210 are used immediately prior to/provide input to the slice attention layer 208 and FFN 212, respectively), to a “post-norm” configuration (e.g., where the normalization layers 206 and 210 are used immediately subsequent to/receive their input from the adders 213 and 217, respectively). Such a post-norm configuration is not shown in the depicted examples. Similarly, in some aspects, the architecture 200 may forgo or exclude skip connections 211 and/or 215.

### Example Slice Attention Layer Architecture

FIG. 3 depicts an example slice attention layer architecture 300. In some aspects, the architecture 300 provides additional detail for the slice attention layer 208 of FIG. 2. Specifically, in some aspects, block 306 may correspond to the slice attention layer 208, and the depicted components and operations therein may be included in the slice attention layer 208 of FIG. 2.

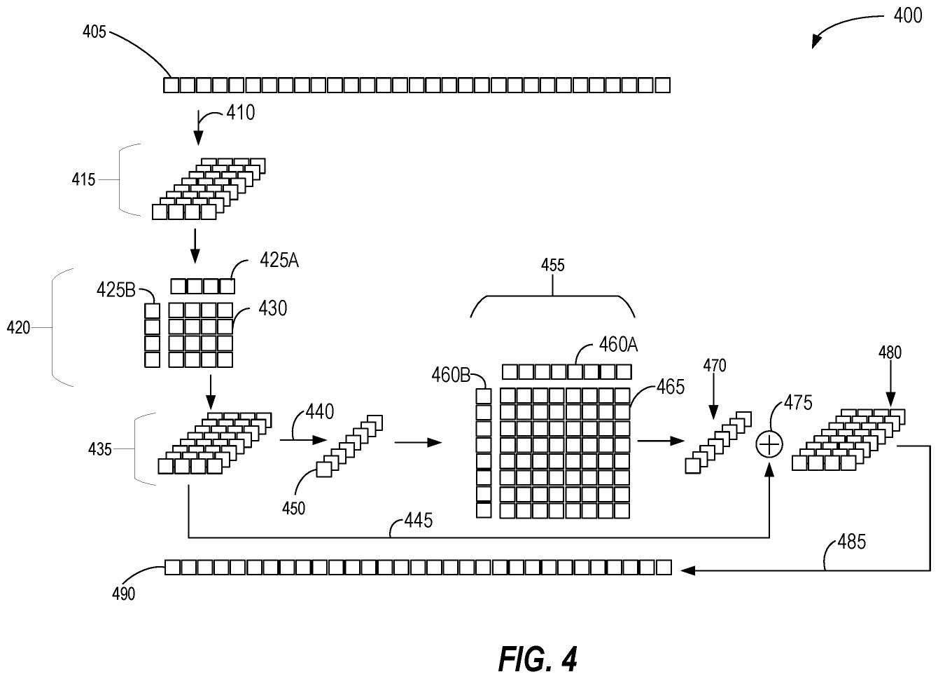

As illustrated, input 305 (of size [symbol] ^{N×D}) is provided to a slicing layer 310, which slices the sequence based on a slice length hyperparameter L in order to generate N/L slices of the input 305, each of length L. In some aspects, L is a factor of N, allowing for the input to be sliced into an integer number of slices. In some aspects, L may not be a factor of N, and padding may be added to one or more of the slices to form an integer number of slices of equal length. These slices are then stacked (as discussed in more detail below with reference to FIG. 4) to generate a stacked slice input data representation of size [symbol] ^{N/L×L×D}. That is, the stacked slice input data representation may be formed by concatenating or stacking the slices to form an aggregate tensor.

As discussed above with reference to FIG. 2, the input is therefore used to form a stacked slice data representation (Sin the description above). A first, local (high- or full-resolution) attention is then performed on the input data at section 315 by initially adding local positional embeddings Pₗ (output by the embedding function 314, (which may correspond to embedding function 207 of FIG. 2) based on embedding layer 312 (which may correspond to embedding layer 202 of FIG. 2)) to the input data for generating the keys and queries, but not the input data for generating the values (as described above), at adder 320. Then, a set of local attention parameters 325A-C(denoted W_{q,l}, W_{k,l}, and W_{v,l} in the illustrated example) are applied to the stacked slice data representation (augmented by the local positional embeddings, in the case of the keys and queries) to generate local queries Qₗ, local keys Kₗ, and local values Vₗ. In some aspects, the local attention parameters 325 may be referred to as a set of local weights, a set of local trained weights, a set of local learned weights, a first set of weights, a first set of trained weights, a first set of local weights, and the like. Matrix multiplications are then performed at local attention element 330, as described above, to generate local attention output data of size [symbol] ^{N/L×L×D}.

That is, the local attention mechanism (indicated by section 315) includes the addition of the local positional embeddings at adder 320, application of the local attention parameters 325 (also referred to as weights), and finally use of the local attention element 330 (e.g., to compute the local attention, such as by using Equation 15 above). Generally, the illustrated example depicts performing the local attention (in section 315) in a specific arrangement (e.g., including use of positional embeddings to a subset of the matrices). However, other configurations may be used in some aspects (e.g., the positional embeddings may be added to the value matrix as well as the key and query matrices, positional embeddings may be excluded or unused for one or more of the matrices, and the like).

In some aspects, as discussed above, the local attention parameters 325 are trainable (e.g., learned) parameters. In some aspects described herein, the first (local) attention is referred to as high-resolution. As used herein, this local attention may be referred to as “high” resolution to indicate that the local attention uses or has a higher resolution than that of the second (global) attention (e.g., up to and including full-resolution). That is, in some aspects, the global attention may be performed in a reduced resolution (e.g., by abstracting or aggregating one or more tokens or elements in the sequence into a sequence with fewer elements, such as by grouping multiple elements into a single element, and performing global attention on this relatively smaller sequence, as compared to the length of the original sequence). This can improve efficiency and computational expense. In some aspects, the local attention may be performed in relatively higher resolution (e.g., with less abstraction, such as by aggregating fewer elements together, and/or by using no abstraction, such as by evaluating the slices at full (original) resolution).

In the illustrated example, the local attention output data (output by the local attention element 330) is then processed by a slice embedding element 335 to resize the data to [symbol] ^{N/L×1×D}. As described above, the slice embedding element 335 may implement an abstraction function, such as mean pooling within each slice in some examples, to generate the slice embeddings. As discussed below, this abstraction (e.g., mean pooling within each slice) allows the global attention to operate more efficiently or with reduced expense, as the global attention uses a relatively lower resolution (as compared to operating on the original input tokens).

As illustrated, a second, global (and reduced- or low-resolution) attention is performed on the slice embeddings at section 345 by initially adding global positional embeddings P_{g} (output by the embedding function 344 (which may correspond to embedding function 209 of FIG. 2) based on embedding layer 312 (which may correspond to embedding layer 202 of FIG. 2)) to the local attention output data for generating the keys and queries, but not for the input used to generate the values, at adder 350. Note that unlike the local positional embeddings, Pₗ, the global positional embeddings P_{g} are sized [symbol] ^{N/L×1×D} consistent with the size of the slice embeddings.

As illustrated, a set of global attention parameters 355A-C (denoted W_{q,g}, W_{k,g}, and W_{v,g} in the illustrated example) are applied to the slice embeddings (augmented by the global positional embeddings for the keys and queries) to generate global queries Q_{g}, global keys K_{g}, and global values V_{g}. In some aspects, the global attention parameters 355 may be referred to as a set of global weights, a set of global trained weights, a set of global learned weights, a second set of weights, a second set of trained weights, a second set of local weights, and the like. Matrix multiplications are then performed at global attention element 360, as described above, to generate global attention output data of size [symbol] ^{N/L×1×D}.

That is, the global attention mechanism (indicated by section 345) includes the addition of the global positional embeddings at adder 350, application of the global attention parameters 355 (also referred to as weights), and finally use of the global attention element 360 (e.g., to compute the global attention, such as by using Equation 16 above).

In some aspects, as discussed above, the global attention parameters 355 are trainable (e.g., learned) parameters. In some aspects described herein, the second (global) attention is referred to as low-resolution and/or reduced resolution. As used herein, this global attention may be referred to as “low” or “reduced” resolution in some aspects to indicate that the global attention uses or has a lower resolution than that of the first (local) attention (e.g., that the input to global attention may be abstracted or otherwise reduced to a smaller number of tokens or elements, as compared to the original input sequence). In some aspects, rather than reduced resolution, the global attention may similarly operate at full (or higher) resolution, in a similar manner to the local attention.

In the illustrated example, the output from global attention element 360 is then broadcast added to the local attention output (output by the local attention element 330) by way of skip connection 340 and adder 365. Here, adder 365 performs a broadcast addition owing to the difference in size between the output from global attention element 360 ( [symbol] ^{N/L×1×D}) and the local attention output ( [symbol] ^{N/L×L×D}).

As depicted, the output of the adder 365 is then provided to a de-slicing layer 370, which transforms the output from a stacked slice shape to a sequence shape [symbol] ^{N×D}, matching the original input data to the slicing layer 310.

Finally, linear layer 375 performs a linear transformation to generate the stacked slice output data 380.

FIG. 4 depicts an example data flow 400 for slice attention, as may be implemented by the slice attention layer architecture 300 described with respect to FIG. 3.

As depicted, an input data sequence 405 (e.g., input 305 of FIG. 3) is sliced via operation 410 (e.g., based on a slice length hyperparameter using the slicing layer 310 of FIG. 3) to generate a stacked slice representation 415. The stacked slice representation is then processed by all or a part of a slice attention layer (e.g., a local attention element 420 (e.g., section 315 of FIG. 3)), which may have complexity

$$O ( \frac{N}{L} {L}^{2} ) ,$$

to generate local attention output 435. As discussed above, the local attention element may be referred to as “high-resolution” in some aspects. In the illustrated example and as discussed above, the local attention element 420 generally includes application of trained or learned weights (e.g., a key weight and/or query weight with values learned during training of the model) to each slice of the stacked slice representation 415 (thereby generating query matrix 425B (e.g., query matrix 104 of FIG. 1) and key matrix 425A (e.g., key matrix 106 of FIG. 1). These matrices 425 are then combined (e.g., using matrix multiplication) to generate intermediate matrix 430 (e.g., intermediate matrix 108 of FIG. 1), which is then combined (e.g., using matrix multiplication) with the value matrix (e.g., value matrix 110 of FIG. 1, which is similarly generated using trained or learned weights, such as value weights having values learned during training of the model) to generate an output local attention for the slice. Although the illustrated example depicts applying the local attention for a single slice, in aspects, the local attention element 420 can operate on the entire stacked slice representation 415. Additionally, though generating and use of one or more weights to generate key, query, and value matrices are discussed above, in some aspects, the local attention may generally include a wide variety of operations to generate the local attention output.

As illustrated, the local attention output 435 is then processed by an abstraction function 440 (e.g., slice embedding element 335 of FIG. 3) to generate slice embeddings 450. The slice embeddings 450 are then processed by a global attention element 455 (e.g., section 345 of FIG. 3), which may have complexity

$$O ( \frac{{N}^{2}}{{L}^{2}} ) ,$$

to generate global attention output 470. As discussed above, the global attention element may be referred to as “reduced-resolution” in some aspects, due to this abstraction function 440. That is, because the global attention may be performed on the slice embeddings 455 (generated by abstracting the abstraction function 440), rather than directly on the input tokens, the global attention may be considered relatively lower resolution, as compared to the local attention. As discussed above, the global attention element 455 may generally apply learned parameters (e.g., key weight and/or query weight) to generate query matrix 460B and/or key matrix 460A, which are combined to create intermediate matrix 465, which is then combined with the value matrix to yield the global attention output 470.

As illustrated, the global attention output 470 is then broadcast added via adder 475 (e.g., adder 365 of FIG. 3) to the local attention output 435 (provided via skip connection 445) to generate stacked slice output data 480. Finally, the stacked slice output data is de-sliced using operation 485 (e.g., using de-slicing layer 370 of FIG. 3) to provide an output data sequence 490 (e.g., slice output data 380).

### Overcoming Context Fragmentation—Overlapped Local Attention and Focal Attention

To avoid context fragmentation with the sliced data representations used in composite slice transformer models, overlapped attention may be used in some aspects. That is, in some aspects, context fragmentation can be caused due to the local attention being strictly bounded to consider only other elements within the same slice, meaning that elements near the beginning and end of each slice may lose valuable context contained in one or more elements in the adjacent slices. By using overlapping attention, in some aspects, such context fragmentation can be reduced or avoided.

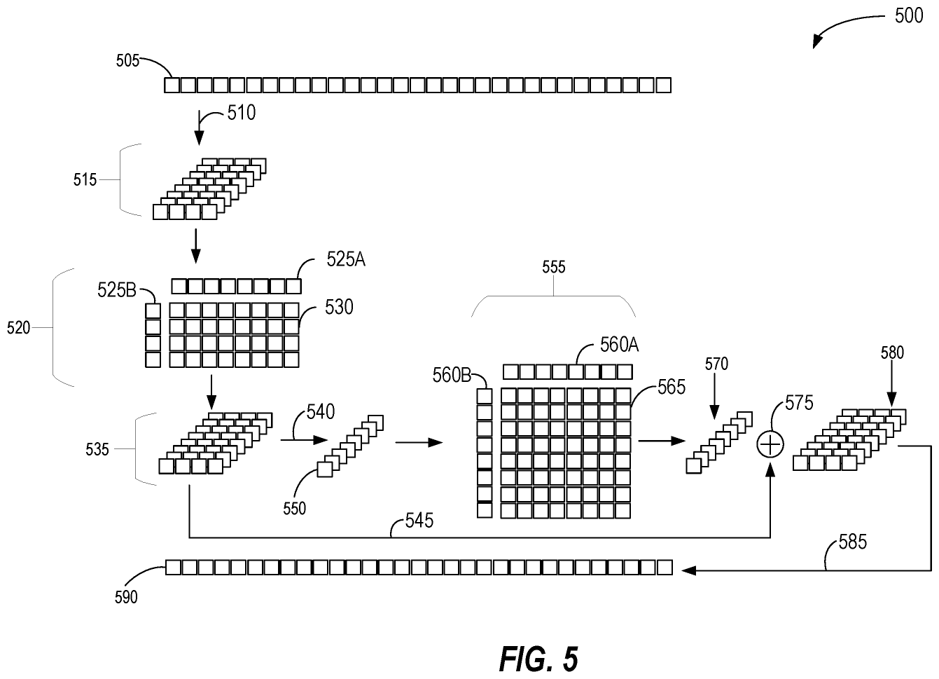

FIG. 5 depicts an example data flow 500 for slice attention using overlapped slice attention (referred to as overlapping slice local attention in some aspects), as may be implemented by the slice layer architecture described with respect to FIG. 3. Flow 500 proceeds in much the same way as flow 400 of FIG. 4, however, the local attention element 520 uses overlapping local attention in which slices are overlapped to regain context information lost by the slicing operation. That is, allowing slices to overlap can allow for the local attention to be generated for each element with fuller context of the element (e.g., based on additional neighboring elements), rather than using strict non-overlapping slices that fragment the context of some elements in the slices. As can be seen, the overlapping does come at the cost of additional complexity based on the ratio of overlap, increasing the overall complexity to

$$O ( a \frac{N}{L} {L}^{2} ) ,$$

where a is a hyperparameter specifying the amount of overlap.

In some aspects, the overlapped local attention is implemented by generating the local attention output 535 based on overlapping slices in the stacked slice representation 515. For example, in the illustrated aspect, the local attention element 520 computes the local attention output 535 based on pairs of slices concatenated (e.g., by doubling the width of the key vector 525A (also referred to in some aspects as the local key vector, matrix, or tensor) and the value vector (also referred to in some aspects as the local value vector, matrix, or tensor)).

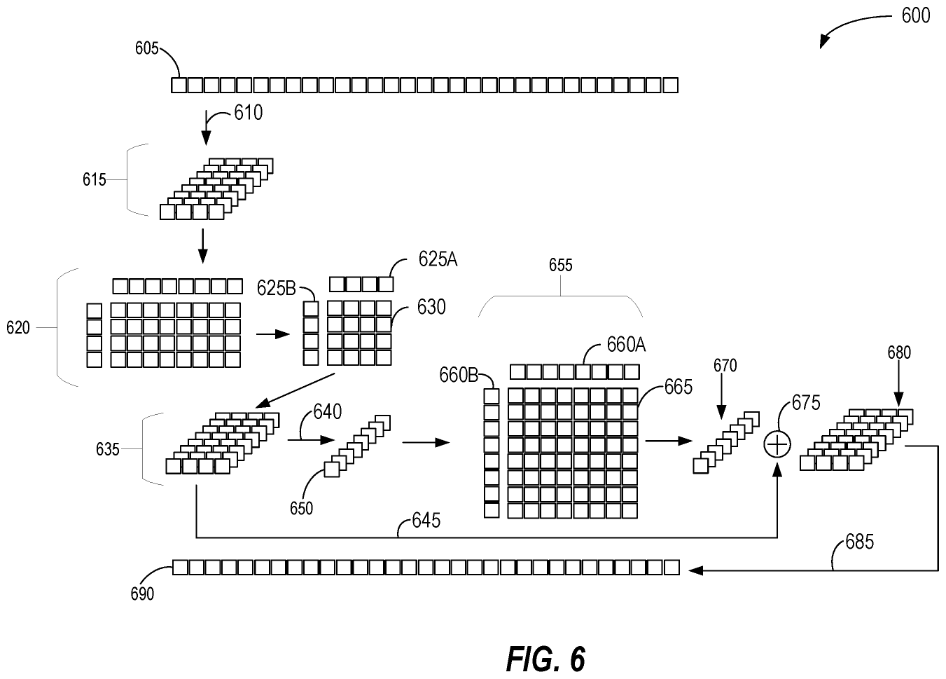

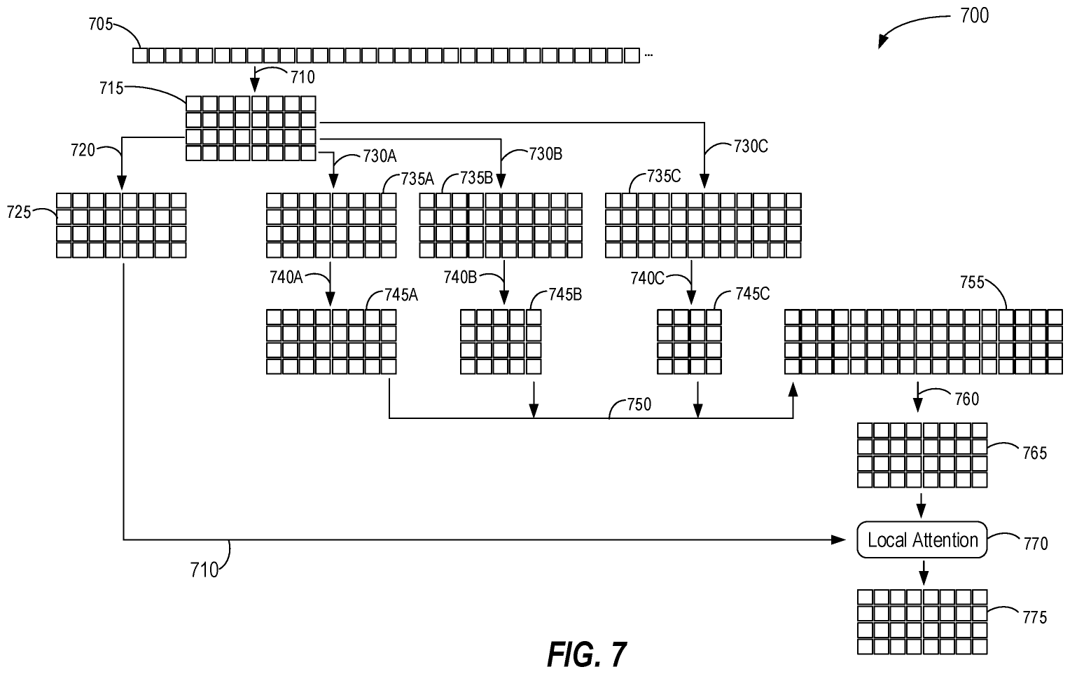

In some aspects, to address the complexity impact from overlapped attention when using a sliced data representation, focal attention (also referred to in some aspects as focal slice attention) may be utilized as a more efficient way of creating overlap. FIG. 6 depicts an example data flow 600 for slice attention using focal local attention, as may be implemented by the slice layer architecture described with respect to FIG. 3. Flow 600 proceeds in much the same way as flow 500 of FIG. 5, however, at the local attention element 620 uses segment-wise focal local attention (depicted by elements 625A and 625B), which is described in more detail with respect to FIG. 7. Unlike some conventional attempts at focal attention, in aspects described herein, one-dimensional sliced sequences are used to achieve an intermediate between local and global attention. This can be performed by taking sequences of different overlapping lengths of the query sequence, as discussed above with reference to FIG. 5. Suppose a slice of the input sequence N_{w(l-1):wl} is taken, where w is the width of the slice, and l is the l^{th} slice in the sequence. This forms the query matrix. For the key and value matrices, multiple different sequence lengths can be taken. For example, the system may use the below four sequence lengths:

(K,V)_{w(l-1):w}¹

(K,V)_{w(l-1-α):wl+a}

(K,V)_{w(l-1-2α):wl+2a}

(K,V)_{w(l-1-4α):wl+4a}

In the expressions above, a is a selectable overlap ratio. In some aspects, the key and value sequences can then be passed through different pooling and/or convolution operations to merge the information, as discussed in more detail below with reference to FIG. 7. Generally, the longer the sequences, the larger the pooling and the coarser the information in the output sequences. These sequences may then be concatenated and convolved to achieve the original dimension as the query, which allows for bringing down the complexity of composite slice transformer from

$$O ( α \frac{N}{L} {L}^{2} ) to O ( \frac{N}{L} {L}^{2} ) .$$

FIG. 7 depicts an example workflow 700 to implement focal slice local attention. As described above, the stacked slice representation can be transformed using different sequence lengths to create overlap. These difference sequences can then be individually pooled or convolved, and then concatenated to generate the overlapped stacked slice representation. The overlapped stacked slice representation can then be convolved to reshape the data so that local attention can be applied and focal local attention output can be generated (which can then be processed through the remainder of the composite slice transformer architecture as described above).

Specifically, in the illustrated example, an input data sequence 705 (e.g., input data sequence 405 of FIG. 4) is received, and processed using a data slicing operation 710 (e.g., slicing layer 310 of FIG. 3) to generate a stacked slice representation 715. In some aspects, the stacked slice representation 715 is generated using overlapping slices, as discussed above with reference to FIGS. 5 and 6. In some aspects, as discussed below, the slicing operation 710 may generate slices of multiple different lengths (defined by the slice length hyperparameter) and/or with multiple different amounts of overlap (defined by the overlap hyperparameter). That is, the slicing operation may be used to generate multiple stacked slice representations, each having a different length or size. In the illustrated example, via operation 720, the stacked slice representation 715 is used to generate the query matrix 725. For example, the operation 720 may correspond to applying local query weight(s) (e.g., query weight 103 of FIG. 1 and/or local attention parameter 325C of FIG. 3) to the stacked slice representation 715 to generate the query matrix 725 (e.g., query matrix 104 of FIG. 1).

In the illustrated example, via operations 730A-C, the system can further generate a set of intermediate tensors or matrices 735A-C(collectively referred to herein as “tensors 735” or “matrices 735”), which are used to generate the key and value matrices 745A-C for attention operations, such as by using operations 740A-C(e.g., convolution), as discussed below. In the illustrated example, the intermediate matrices 735 may correspond to value matrices (e.g., matrices generated using the value weight 109 of FIG. 1 and/or local attention parameter 325A of FIG. 3) and/or key matrices (e.g., matrices generated using the key weight 105 of FIG. 1 and/or local attention parameter 325B of FIG. 3). That is, the same operations may be used to generate the overlapped stacked slice representation of each, followed by a convolution operation to reshape the overlapped stacked slice representation of each to the same dimensionality as the query matrix 725.

As illustrated, the operations 730 correspond to application of the key weight and/or value weight to the stacked slice representation(s) 715 in order to generate intermediate matrices 735A-C. As illustrated, each operation 730 corresponds to a different size matrix. Specifically, if the query matrix 725 is Q_{w(l-1):wl} (e.g., a first size, such as w(l−1) by wl), then the intermediate matrix 735A has the same size (e.g., K_{w(l-1):wl} for the key matrix, and V_{w(l-1):wl} for the value matrix). As illustrated, the intermediate matrix 735B is larger (e.g., K_{w(l-1)-1:wl+1} for the key matrix, and V_{w(l-1)-1:wl+1} for the value matrix) than the intermediate matrix 735A. Similarly, the intermediate matrix 735C is larger than the intermediate matrix 735B (e.g., K_{w(l-1)-2:wl+2} for the key matrix, and V_{w(l-1)-2:wl+2} for the value matrix). In this way, as the intermediate matrices 735B and 735C include additional elements that overlap with neighboring slices in the stacked slice representation 715, the system can prevent context fragmentation by generating the local attention based in part on these overlapping elements.

In the illustrated example, the intermediate tensors 735 are then processed via convolution operations 740 to generate a new set of intermediate tensors 745. As illustrated, the system generally uses larger convolution kernels for larger intermediate tensors 735 (thereby reducing the size of the resulting intermediate kernel 745). Specifically, in the illustrated example, the convolution operation 740A does not change the size of the intermediate matrix 735A (e.g., a 1×1×d×d convolution is used), the convolution operation 740B results in a somewhat smaller intermediate matrix 745B, as compared to the intermediate matrix 735B (e.g., a 2×1×d×d convolution is used), and the convolution operation 740C results in a significantly smaller intermediate matrix 745C, as compared to the intermediate matrix 735C (e.g., a 3×1×d×d convolution is used).

In aspects, the actual sizes of the intermediate tensors or matrices 735 and/or the convolution operations 740 may vary depending on the particular implementation (e.g., depending on the value of a). Additionally, though three intermediate tensors 735 are depicted, in aspects, the system may generate any number of intermediate tensors 735 of various sizes.

As illustrated, the intermediate tensors 745A-C are then concatenated via operation 750 to generate an overlapped stacked slice representation 755. As this overlapped stacked slice representation 755 is substantially larger than the query matrix 725, in the illustrated workflow 700, a convolution operation 760 is used to reshape the overlapped stacked slice representation 755 and change its size to match the dimensionality of the query matrix 725. For example, in the illustrated aspect, a 1×1×17×8 convolution is used to generate the matrix 765 (e.g., the key matrix in the case that the operations 730 used the key weights and/or value matrix in the case that the operations 730 used the value weights). In some aspects, as discussed above, the operation 760 may further include a transpose operation in the case of the key matrix (e.g., to prepare the key matrix for matrix multiplication using the attention mechanism).

In the illustrated example, the matrices 765 (e.g., the key matrix and value matrix, generated using overlapped slices) and query matrix 725 are then provided to the local attention mechanism 770 (e.g., local attention element 330 of FIG. 3 and/or local attention element 620 of FIG. 6), which generates focal local attention output 775, as discussed above. In the illustrated example, because the key and value matrices were generated using overlapped slices, the focal local attention output 775 can prevent or reduce context fragmentation, thereby resulting in improved model accuracy (without incurring the additional overhead introduced using the overlapped approach described with reference to FIG. 5).

### Example Method

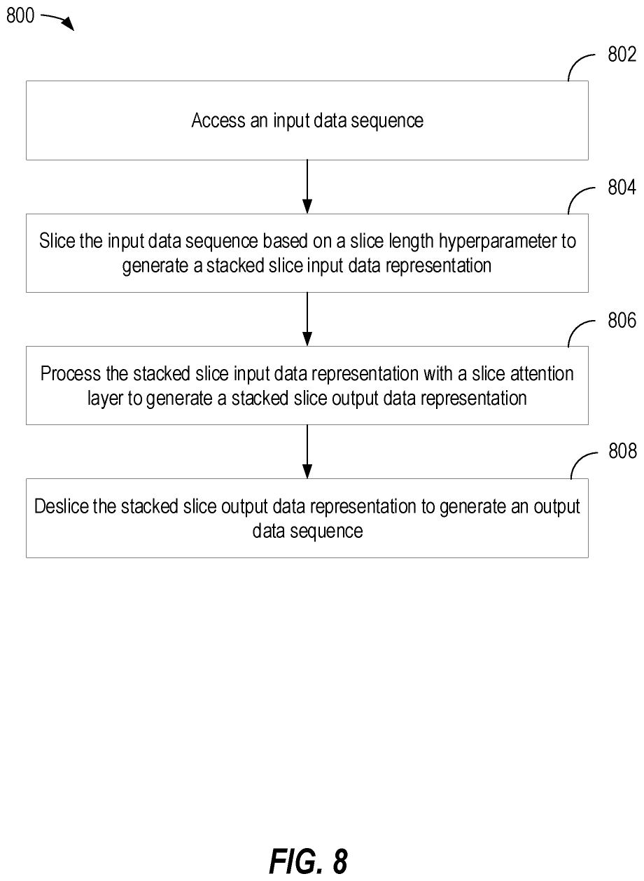

FIG. 8 depicts an example method 800 for performing machine learning with slice attention.

Method 800 begins at block 802 with accessing an input data sequence, such as described above with respect to input 305 and FIG. 3.

At block 804, the input data sequence is sliced based on a slice length hyperparameter to generate a stacked slice input data representation, such as described above with respect to FIG. 3 and slicing layer 310.

At block 806, the stacked slice input data representation is processed with a slice attention layer to generate a stacked slice output data representation, such as described above with respect to FIG. 2 and slice attention layer 208, as well as with respect to the slice attention layer architecture 300 (e.g., sections 315 and/or 345) of FIG. 3

At block 808, the stacked slice output data representation is de-sliced to generate an output data sequence, such as described above with respect to FIG. 3 and de-slicing layer 370.

In some aspects, processing the stacked slice input data representation with the slice attention layer to generate the stacked slice output data representation comprises: processing the stacked slice input data representation with a high-resolution local attention layer (e.g., section 315 of FIG. 3) to generate local attention output data, processing the local attention output data with a slice embedding layer (e.g., slice embedding element 335 of FIG. 3) to generate slice embeddings, processing the slice embeddings with a reduced-resolution global attention layer (e.g., section 345 of FIG. 3) to generate global attention output data, and performing a broadcast addition (e.g., via adder 365 of FIG. 3) of the local attention output data and the global attention output data to generate the stacked slice output data representation. One advantage of such an aspect is that the high-resolution local attention may be used to accurately generate local attention, while the reduced-resolution global attention may be used to generate global attention with reduced computational expense.

In some aspects, processing the stacked slice input data representation with the high-resolution local attention layer comprises applying a first set of trained weights (e.g., local attention parameters 325 of FIG. 3) to the stacked slice input data representation, and processing the slice embeddings with a reduced-resolution global attention layer comprises applying a second set of trained weights (e.g., global attention parameters 355 of FIG. 3) to the slice embeddings. One advantage of such an aspect is that the local and global attention layers may use different sets of trained weights, which may improve model performance.

In some aspects, processing the stacked slice input data representation with the high-resolution local attention layer comprises: generating a local key vector (e.g., the key matrix for local attention), a local query vector (e.g., the query matrix for local attention), and a local value vector (e.g., the value matrix for local attention) by applying the first set of trained weights (e.g., local attention parameters 325 of FIG. 3) to the stacked slice input data representation; and generating the local attention output data based on the local key vector, local query vector, and local value vector. One advantage of such an aspect is that the local attention may be generated using weights learned during training for the high-resolution local attention.

In some aspects, processing the stacked slice input data representation with the high-resolution local attention layer further comprises adding a local positional embedding (e.g., via embedding function 207 of FIGS. 2 and 3) to the local key vector and the local query vector, and a length of the local positional embedding is based on the slice length hyperparameter. One advantage of such an aspect is that the positional embeddings may be tailored to account for local positionings based on the slices.

In some aspects, processing the slice embeddings with the reduced-resolution global attention layer comprises: generating a global key vector (e.g., the key matrix for global attention), a global query vector (e.g., the query matrix for global attention), and a global value vector (e.g., the value matrix for global attention) by applying the second set of trained weights (e.g., global attention parameters 355 of FIG. 3) to the slice embeddings; and generating the global attention output data based on the global key vector, global query vector, and global value vector. One advantage of such an aspect is that the global attention may be generated using weights learned during training for the reduced-resolution global attention.

In some aspects, processing the slice embeddings with the reduced-resolution global attention layer comprises adding a global positional embedding (e.g., via embedding function 209 of FIGS. 2 and 3) to the global key vector and the global query vector, and a length of the global positional embedding is based on an input data sequence length divided by the slice length hyperparameter. One advantage of such an aspect is that the positional embeddings may be tailored to account for global positionings.

In some aspects, processing the stacked slice input data representation with the high-resolution local attention layer comprises performing overlapping slice local attention, such as described above with reference to FIGS. 4-5. In some aspects, slicing the input data sequence is performed based further on an overlap hyperparameter to generate overlapping slices of the input data sequence. One advantage of such an aspect is that overlapping slice local attention may reduce or prevent context fragmentation, and/or that the overlapping slices may improve model accuracy.

In some aspects, processing the stacked slice input data representation with the high-resolution local attention layer comprises performing focal slice local attention, such as described above with reference to FIGS. 6-7. In some aspects, slicing the input data sequence comprises generating a plurality of slices having a plurality of sequence lengths, and performing the focal slice local attention comprises: generating a plurality of intermediate tensors based on the plurality of slices; and aggregating the plurality of intermediate tensors. One advantage of such an aspect is that focal slice local attention may reduce or eliminate context fragmentation, and/or that aggregating the intermediate tensors may reduce computational expense.

In some aspects, the slice attention layer comprises a plurality of slice attention heads (e.g., a plurality of slice attention modules 205 of FIG. 2). One advantage of such an aspect is that use of multiple slice attention heads may improve accuracy and/or reduce computational expense.

### Example Processing System

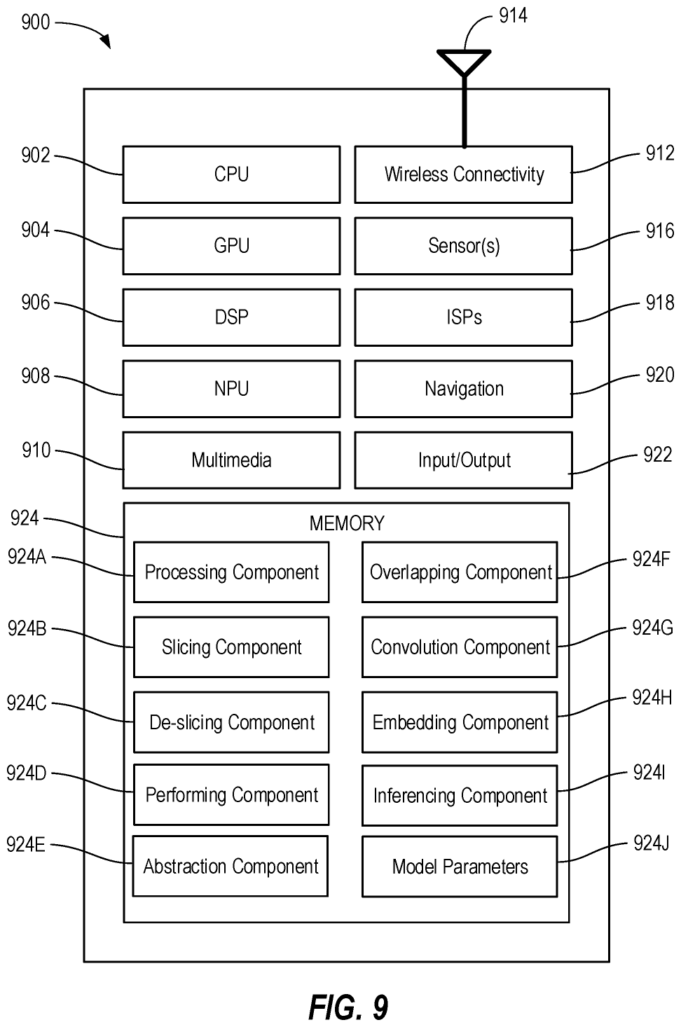

FIG. 9 depicts an example processing system 900 that may be configured to perform the methods described herein, such as with respect to FIGS. 1-8.

Processing system 900 includes a central processing unit (CPU) 902, which in some examples may be a multi-core CPU. Instructions executed at the CPU 902 may be loaded, for example, from a program memory associated with the CPU 902 or may be loaded from memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

In some aspects, one or more of CPU 902, GPU 904, DSP 906, and NPU 908 may be configured to perform the methods described herein with respect to FIGS. 1-8.

An NPU, such as 908, is generally a specialized circuit configured for implementing the control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 908, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this data through an already trained model to generate a model output (e.g., an inference).

In some aspects, NPU 908 may be implemented as a part of one or more of CPU 902, GPU 904, and/or DSP 906.

In some aspects, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned components of processing system 900.

In particular, in this example, memory 924 includes processing component 924A, slicing component 924B, de-slicing component 924C, performing component 924D, abstraction component 924E, overlapping component 924F, convolution component 924G, embedding component 924H, inferencing component 924I, and model parameters 924J (e.g., weights, biases, and other machine learning model parameters). One or more of the depicted components, as well as others not depicted, may be configured to perform various aspects of the methods described herein.

For example, the processing component 924A may perform various processing operations, such as to normalize data (e.g., at normalization layers 206 and 210 of FIG. 2), nonlinear transformations (e.g., via FFN 212 of FIG. 2), linear operations (e.g., via linear layer 375 of FIG. 3), and the like.

Slicing component 924B (which may correspond to (slicing layer 310 of FIG. 3) may generally be used to slice input sequences, as discussed above. De-slicing component 924C (e.g., de-slicing layer 370 of FIG. 3) may generally be used to de-slice the slices to reconstruct a sequence of data.

In some aspects, performing component 924D may generally be used to perform or compute the various attentions (e.g., via slice attention layer 208), which may include local attention (e.g., section 315 of FIG. 3) and/or global attention (e.g., section 345 of FIG. 3).

Abstraction component 924E (which may correspond to slice embedding element 335 of FIG. 3) may generally be used to resize the data and/or provide abstraction (such as via a mean pooling operation).

In some aspects, overlapping component 924F may be used to provide overlapping local attention, such as via local attention element 520 of FIG. 5 and/or local attention element 620 of FIG. 6. In the illustrated example, convolution component 924G may be used to perform various convolution operations, such as to enable focal local attention, as discussed above with reference to FIG. 7). The embedding component 924H (which may correspond to the embedding layer 202 of FIGS. 2 and 3) may generally be used to generate embeddings for the input data.

In the illustrated example, the inferencing component 924I may generally be used to orchestrate one or more of the depicted components to perform inferencing (e.g., to generate output inferences using composite slice attention). The model parameters 924J generally include any parameters of the model(s), such as local attention parameters 325 of FIG. 3, global attention parameters 355 of FIG. 3, and the like.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation processor 920 may be omitted in other aspects. Further, aspects of processing system 900 may be distributed.

Note that FIG. 9 is just one example, and in other examples, alternative processing system with fewer, additional, and/or alternative components may be used.

### Example Clauses

Implementation examples are described in the following numbered clauses:

Clause 1: A computer-implemented method, comprising: accessing an input data sequence; slicing the input data sequence based on a slice length hyperparameter to generate a stacked slice input data representation; processing the stacked slice input data representation with a slice attention layer to generate a stacked slice output data representation; and de-slicing the stacked slice output data representation to generate an output data sequence. One advantage of such an aspect is that the slice attention operation may be performed with reduced computational complexity and/or improved attention output, as compared to some conventional attention operations.

Clause 2: The method of Clause 1, wherein processing the stacked slice input data representation with the slice attention layer to generate the stacked slice output data representation comprises: processing the stacked slice input data representation with a high-resolution local attention layer to generate local attention output data; processing the local attention output data with a slice embedding layer to generate slice embeddings; processing the slice embeddings with a reduced-resolution global attention layer to generate global attention output data; and performing a broadcast addition of the local attention output data and the global attention output data to generate the stacked slice output data representation. One advantage of such an aspect is that the high-resolution local attention may be used to accurately generate local attention, while the reduced-resolution global attention may be used to generate global attention with reduced computational expense.

Clause 3: The method of Clause 2, wherein: processing the stacked slice input data representation with the high-resolution local attention layer comprises applying a first set of trained weights to the stacked slice input data representation, and processing the slice embeddings with a reduced-resolution global attention layer comprises applying a second set of trained weights to the slice embeddings. One advantage of such an aspect is that the local and global attention layers may use different sets of trained weights, which may improve model performance.

Clause 4: The method of any of Clauses 2-3, wherein processing the stacked slice input data representation with the high-resolution local attention layer comprises: generating a local key vector, a local query vector, and a local value vector by applying the first set of trained weights to the stacked slice input data representation; and generating the local attention output data based on the local key vector, local query vector, and local value vector. One advantage of such an aspect is that the local attention may be generated using weights learned during training for the high-resolution local attention.

Clause 5: The method of any of Clauses 2-4, wherein: processing the stacked slice input data representation with the high-resolution local attention layer further comprises adding a local positional embedding to the local key vector and the local query vector, and a length of the local positional embedding is based on the slice length hyperparameter. One advantage of such an aspect is that the positional embeddings may be tailored to account for local positionings based on the slices.

Clause 6: The method of any of Clauses 2-5, wherein processing the slice embeddings with the reduced-resolution global attention layer comprises: generating a global key vector, a global query vector, and a global value vector by applying the second set of trained weights to the slice embeddings; and generating the global attention output data based on the global key vector, global query vector, and global value vector. One advantage of such an aspect is that the global attention may be generated using weights learned during training for the reduced-resolution global attention.

Clause 7: The method of any of Clauses 2-6, wherein: processing the slice embeddings with the reduced-resolution global attention layer comprises adding a global positional embedding to the global key vector and the global query vector, and a length of the global positional embedding is based on an input data sequence length divided by the slice length hyperparameter. One advantage of such an aspect is that the positional embeddings may be tailored to account for global positionings.

Clause 8: The method of any of Clauses 2-7, wherein processing the stacked slice input data representation with the high-resolution local attention layer comprises performing overlapping slice local attention. One advantage of such an aspect is that overlapping slice local attention may reduce or prevent context fragmentation.

Clause 9: The method of Clause 8, wherein slicing the input data sequence is performed based further on an overlap hyperparameter to generate overlapping slices of the input data sequence. One advantage of such an aspect is that the overlapping slices may improve model accuracy.

Clause 10: The method of any of Clauses 2-9, wherein processing the stacked slice input data representation with the high-resolution local attention layer comprises performing focal slice local attention. One advantage of such an aspect is that focal slice local attention may reduce or eliminate context fragmentation.

Clause 11: The method of Clause 10, wherein: slicing the input data sequence comprises generating a plurality of slices having a plurality of sequence lengths, and performing the focal slice local attention comprises: generating a plurality of intermediate tensors based on the plurality of slices; and aggregating the plurality of intermediate tensors. One advantage of such an aspect is that aggregating the intermediate tensors may reduce computational expense.

Clause 12: The method of any of Clauses 1-10, wherein the slice attention layer comprises a plurality of slice attention heads. One advantage of such an aspect is that use of multiple slice attention heads may improve accuracy and/or reduce computational expense.

Clause 13: A processing system, comprising: a memory comprising computer-executable instructions; and one or more processors configured to execute the computer-executable instructions and cause the processing system to perform a method in accordance with any of Clauses 1-12.

Clause 14: A processing system, comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
accessing an input data sequence;
slicing the input data sequence based on a slice length hyperparameter to generate a stacked slice input data representation;
processing the stacked slice input data representation with a slice attention layer to generate a stacked slice output data representation; and
de-slicing the stacked slice output data representation to generate an output data sequence.

2. The method of claim 1, wherein processing the stacked slice input data representation with the slice attention layer to generate the stacked slice output data representation comprises:
processing the stacked slice input data representation with a high-resolution local attention layer to generate local attention output data;
processing the local attention output data with a slice embedding layer to generate slice embeddings;
processing the slice embeddings with a reduced-resolution global attention layer to generate global attention output data; and
performing a broadcast addition of the local attention output data and the global attention output data to generate the stacked slice output data representation.

3. The method of claim 2, wherein:
processing the stacked slice input data representation with the high-resolution local attention layer comprises applying a first set of trained weights to the stacked slice input data representation, and
processing the slice embeddings with the reduced-resolution global attention layer comprises applying a second set of trained weights to the slice embeddings.

4. The method of claim 3, wherein processing the stacked slice input data representation with the high-resolution local attention layer comprises:
generating a local key vector, a local query vector, and a local value vector by applying the first set of trained weights to the stacked slice input data representation; and
generating the local attention output data based on the local key vector, local query vector, and local value vector.

5. The method of claim 4, wherein:
processing the stacked slice input data representation with the high-resolution local attention layer further comprises adding a local positional embedding to the local key vector and the local query vector, and
a length of the local positional embedding is based on the slice length hyperparameter.

6. The method of claim 3, wherein processing the slice embeddings with the reduced-resolution global attention layer comprises:
generating a global key vector, a global query vector, and a global value vector by applying the second set of trained weights to the slice embeddings; and
generating the global attention output data based on the global key vector, global query vector, and global value vector.

7. The method of claim 6, wherein:
processing the slice embeddings with the reduced-resolution global attention layer comprises adding a global positional embedding to the global key vector and the global query vector, and
a length of the global positional embedding is based on an input data sequence length divided by the slice length hyperparameter.

8. The method of claim 2, wherein processing the stacked slice input data representation with the high-resolution local attention layer comprises performing overlapping slice local attention and wherein slicing the input data sequence is performed based further on an overlap hyperparameter to generate overlapping slices of the input data sequence.

9. The method of claim 2, wherein processing the stacked slice input data representation with the high-resolution local attention layer comprises performing focal slice local attention, wherein:
slicing the input data sequence comprises generating a plurality of slices having a plurality of sequence lengths; and
performing the focal slice local attention comprises:
generating a plurality of intermediate tensors based on the plurality of slices, and
aggregating the plurality of intermediate tensors.

10. The method of claim 1, wherein the slice attention layer comprises a plurality of slice attention heads.

11. A processing system, comprising:
a memory comprising computer-executable instructions; and
one or more processors configured to execute the computer-executable instructions to cause the processing system to perform an operation comprising:
accessing an input data sequence;
slicing the input data sequence based on a slice length hyperparameter to generate a stacked slice input data representation;
processing the stacked slice input data representation with a slice attention layer to generate a stacked slice output data representation; and
de-slicing the stacked slice output data representation to generate an output data sequence.

12. The processing system of claim 11, wherein processing the stacked slice input data representation with the slice attention layer to generate the stacked slice output data representation comprises:
processing the stacked slice input data representation with a high-resolution local attention layer to generate local attention output data;
processing the local attention output data with a slice embedding layer to generate slice embeddings;
processing the slice embeddings with a reduced-resolution global attention layer to generate global attention output data; and
performing a broadcast addition of the local attention output data and the global attention output data to generate the stacked slice output data representation.

13. The processing system of claim 12, wherein:
processing the stacked slice input data representation with the high-resolution local attention layer comprises applying a first set of trained weights to the stacked slice input data representation, and
processing the slice embeddings with the reduced-resolution global attention layer comprises applying a second set of trained weights to the slice embeddings.

14. The processing system of claim 13, wherein processing the stacked slice input data representation with the high-resolution local attention layer comprises:
generating a local key vector, a local query vector, and a local value vector by applying the first set of trained weights to the stacked slice input data representation; and
generating the local attention output data based on the local key vector, local query vector, and local value vector.

15. The processing system of claim 14, wherein:
processing the stacked slice input data representation with the high-resolution local attention layer further comprises adding a local positional embedding to the local key vector and the local query vector, and
a length of the local positional embedding is based on the slice length hyperparameter.

16. The processing system of claim 13, wherein processing the slice embeddings with the reduced-resolution global attention layer comprises:
generating a global key vector, a global query vector, and a global value vector by applying the second set of trained weights to the slice embeddings; and
generating the global attention output data based on the global key vector, global query vector, and global value vector.

17. The processing system of claim 16, wherein:
processing the slice embeddings with the reduced-resolution global attention layer comprises adding a global positional embedding to the global key vector and the global query vector, and
a length of the global positional embedding is based on an input data sequence length divided by the slice length hyperparameter.

18. The processing system of claim 12, wherein processing the stacked slice input data representation with the high-resolution local attention layer comprises performing overlapping slice local attention.

19. The processing system of claim 12, wherein processing the stacked slice input data representation with the high-resolution local attention layer comprises performing focal slice local attention.

20. The processing system of claim 11, wherein the slice attention layer comprises a plurality of slice attention heads.

21. A non-transitory computer-readable medium comprising computer-executable instructions that, when executed by one or more processors of a processing system, cause the processing system to perform an operation comprising:
accessing an input data sequence;
slicing the input data sequence based on a slice length hyperparameter to generate a stacked slice input data representation;
processing the stacked slice input data representation with a slice attention layer to generate a stacked slice output data representation; and
de-slicing the stacked slice output data representation to generate an output data sequence.

22. The non-transitory computer-readable medium of claim 21, wherein processing the stacked slice input data representation with the slice attention layer to generate the stacked slice output data representation comprises:
processing the stacked slice input data representation with a high-resolution local attention layer to generate local attention output data;
processing the local attention output data with a slice embedding layer to generate slice embeddings;
processing the slice embeddings with a reduced-resolution global attention layer to generate global attention output data; and
performing a broadcast addition of the local attention output data and the global attention output data to generate the stacked slice output data representation.

23. The non-transitory computer-readable medium of claim 22, wherein:
processing the stacked slice input data representation with the high-resolution local attention layer comprises applying a first set of trained weights to the stacked slice input data representation, and
processing the slice embeddings with the reduced-resolution global attention layer comprises applying a second set of trained weights to the slice embeddings.

24. The non-transitory computer-readable medium of claim 23, wherein processing the stacked slice input data representation with the high-resolution local attention layer comprises:
generating a local key vector, a local query vector, and a local value vector by applying the first set of trained weights to the stacked slice input data representation; and
generating the local attention output data based on the local key vector, local query vector, and local value vector.

25. The non-transitory computer-readable medium of claim 24, wherein:
processing the stacked slice input data representation with the high-resolution local attention layer further comprises adding a local positional embedding to the local key vector and the local query vector, and
a length of the local positional embedding is based on the slice length hyperparameter.

26. The non-transitory computer-readable medium of claim 23, wherein processing the slice embeddings with the reduced-resolution global attention layer comprises:
generating a global key vector, a global query vector, and a global value vector by applying the second set of trained weights to the slice embeddings; and
generating the global attention output data based on the global key vector, global query vector, and global value vector.

27. The non-transitory computer-readable medium of claim 26, wherein:
processing the slice embeddings with the reduced-resolution global attention layer comprises adding a global positional embedding to the global key vector and the global query vector, and
a length of the global positional embedding is based on an input data sequence length divided by the slice length hyperparameter.

28. The non-transitory computer-readable medium of claim 22, wherein processing the stacked slice input data representation with the high-resolution local attention layer comprises performing overlapping slice local attention.

29. The non-transitory computer-readable medium of claim 22, wherein processing the stacked slice input data representation with the high-resolution local attention layer comprises performing focal slice local attention.

30. A processing system, comprising:
means for accessing an input data sequence;
means for slicing the input data sequence based on a slice length hyperparameter to generate a stacked slice input data representation;
means for processing the stacked slice input data representation with a slice attention layer to generate a stacked slice output data representation; and
means for de-slicing the stacked slice output data representation to generate an output data sequence.
